(19) United States
(12) Patent Application Publication
(10) Pub. No.: US 2010/0299880 A1
(43) Pub. Date: Dec. 2, 2010

(54) Polypropylene Fabric and Its Use in the "Personal Care" Field

(75) Inventor: Luigi Pezzoli, Cene (IT)

Correspondence Address: NIXON & VANDERHYE, PC, 901 NORTH GLEBE ROAD, 11TH FLOOR, ARLINGTON, VA, 22203, US

(73) Assignee: Sitip S.p.A.,, Cene (IT)

(21) Appl. No.: 12/791,279

(22) Filed: Jun. 1, 2010

Related U.S. Application Data
(63) Continuation-in-part of application No. 10/516,011, filed on May 9, 2005, now abandoned.

(51) Int. Cl. B32B 5/02; A44B 99/00

(52) U.S. Cl. 24/1; 428/219

(57) ABSTRACT

A fabric based on raw or pulp-colored polypropylene is intended in particular for use as a “mechanical fastener” of the hook and loop type and utilization of the fabric in health and personal care sector.

This application is a continuation-in-part (CIP) of U.S. patent application Ser. No. 10/516,011, filed May 9, 2005, pending, which is the U.S. national phase of PCT International Patent Application No. PCT/IT2002/000356, filed May 31, 2002, which designated the U.S., the entire contents of each of which are hereby incorporated by reference in this application.

### OBJECT OF THE INVENTION

The present invention relates to a fabric from polypropylene, either raw or pulp-colored, intended in particular for a mechanical fastener of the hook and loop type. The fabric is suitable for use in several sectors and in particular for use in personal care.

### KNOWN ART

As is known, polymers of synthetic origin that are especially utilized in the production of yarns and therefore of fabrics suitable for the most different uses, comprise, for instance, polyamide, polyester and polypropylene. These polymers are treated according to traditional techniques and then utilised, either alone or coupled with each other or to other fabrics, for instance, of natural origin, for the realization of various kinds of fabrics intended for the most different sectors, from sports and casual clothing to industrial, health and personal care sectors, cars, shoes, furnishings, abrasive articles, and the like.

Polypropylene has always captured a great attention because of two main reasons: first, it is rather “economical” with respect to other polymers, for instance the aforementioned ones, and second, it is entirely recyclable and non-toxic, allowing therefore to realize products having a reduced impact on the environment.

There are at present on the market polypropylene yarns having a yarn count in excess of 70 deniers which have however a limited application field and which are used for products belonging to very limited sectors.

The process commonly utilized today for the realization of polypropylene yarns requires many distinct steps that involve such a cost of manpower as to render the obtained product very expensive, canceling out therefore the advantage of the low cost of the starting products.

One of the main problems arises from the fact that the processes for the realization of polypropylene yarns are very complex, as they comprise many separate working steps, and are often very long, thereby causing the production of polypropylene yarns to be very expensive. In practice, even though the raw material (polymer/fiber) is rather advantageous from an economic point of view, process difficulties and working times render the spun and finished product very expensive and not convenient from a commercial point of view.

### OBJECTS OF THE INVENTION

An object of the present invention is to provide polypropylene fabrics intended, for instance, for mechanical fastening systems of the hook and loop type, and that are applicable to products of different fields, and in particular the health and personal care fields, being essentially non-toxic and entirely recyclable.

Another object of the present invention is to provide a polypropylene fabric having a low count of yarns and weight, such as not to lose the economic advantages ensuing from the low starting cost of polypropylene.

A further object of the present invention is to provide a fastening system of the hook and loop type realized with a polypropylene fabric coupleable by heat and ultrasound and needing no glues/resins that jeopardize the natural non-toxicity and recyclable nature of the product.

Still a further object of the invention is to provide a process for the preparation of a fabric from polypropylene that involves only a few steps, that is rapid and that supplies a product advantageous from an economic point of view.

### SUMMARY

These and still further objects and related advantages that will be better stressed by the following description are achieved by a polypropylene-based fabric having a weight comprised between 10 and 300 g/m², suitable to engage with hook elements of another fabric/component, and made up by yarns that come in the form of needle loops (eyelets), that comprise at least a base yarn and at least a knitted fabric that protrudes towards the outside of at least a side of the fabric.

Always according to the present invention, the polypropylene-based fabric has a weight comprised between 10 and 150 g/m², preferably between 10 and 100 g/m². It was found also that it is possible to advantageously realize polypropylene-based fabrics according to the invention having a weight comprised between 10 and 50 g/m² that have all the advantages that will be described below.

According to the present invention, the polypropylene-based fabric comprises at least a continuous and/or discontinuous yarn and can be worked on ladder-proof, weft insertion, rachel, stitch-bonding, circular knitting, chain-weft looms.

More particularly, the polypropylene fabric may be based on a continuous mono-filament and/or a multi-filament yarn.

The polypropylene fabric according to the invention is entirely recyclable, does not affect the environment, and provides big advantages with respect to compatibility with other polypropylene components. In particular, a great advantage arises from the fact that the fabric according to the present invention may be ultrasound and/or heat coupled, without having to use glues or resins that would jeopardize its natural non-toxicity and recycling possibility. The fabric can be bonded by heat or ultrasound to a backing substrate due at least partly to the presence of counter-loops that improve the adherence with the basic fabric and back melting and ensure better bonding and stability. Main loops opposite from the back surface of the fabric, i.e., arranged on the upper part of the fabric, ensure the coupling with the male part of the hook and loop system.

As is known, polypropylene is actually today the fittest product to be used and widespread in many sectors, for instance, to realize fabrics for use in abrasive, car, furniture, clothing, footwear, electronic, geotextile, and in particular, personal care sectors. The so realized polypropylene fabric keeps unaltered the economic characteristics of the starting product, and conquers a market space previously non accessible because of the high working costs of the processes according to the known art. The advantages obtained from a low cost polypropylene fabric are numberless, and only some of them will be stressed hereunder:

as polypropylene is a 100% recyclable product, the products that can be realized have no ecological and environmental impact at all and may be advantageously employed in many applications, as for instance in the personal care sector;

polypropylene is a product having high hydrophobia characteristics and is therefore suitable for all applications wherein avoiding the formation of mildew, the proliferation of microorganisms and bacteria of various types is important. In particular, polypropylene is suitable for use in the personal care field wherein marked hydrophobia, together with its entire recycling possibility and tendential non-toxicity, cause it to be very interesting and compatible for subsequent operations;

polypropylene is a low melting point product and therefore suitable for all types of ultrasound and/or heat coupling, without having to use resins and glues; with respect to some synthetic products of the known art, polypropylene is characterized by a specific weight lower by about ⅓ compared, for instance, to polyamide, and therefore, the diameter of the yarn being equal, the product realized with polypropylene is much lighter and has a lower yarn count with respect to a like product made from polyamide.

Therefore, according to the described embodiments, it is possible to realize a polypropylene fabric having a yarn count lower than or equal to 150 deniers, which is advantageous from an economic point of view and which is therefore of commercial interest.

According to the present invention, it is possible to realize fabrics having various characteristics. In particular, it is possible to utilize a continuous mono-filament or multi-filament yarn from polypropylene, and to obtain a fabric of the so-called terry type, or it is possible to realize a fabric of the raised type, using for the weaving two-, three-, four-comb looms (multi-bar) of the ladder-proof type. In this case, starting from a 100% polypropylene yarn, 100% recyclable fabrics are obtained that have many advantages, especially if they can be produced and marketed to costs contained and competitive with respect to equivalent fabrics realized from non recyclable material.

Always according to the present invention, it is possible to realize a fabric wherein the continuous (mono-filament and/or multi-filament) polypropylene yarn is meshed with a variable percentage of discontinuous polypropylene yarn. Also in this case, the fabric that is obtained, being entirely made from polypropylene, is 100% recyclable and shows the aforesaid advantages.

Further, according to the invention, it is possible to realize a fabric that comprises a variable percentage of continuous (mono-filament and/or multi-filament) polypropylene yarn associated to a variable percentage of yarn compatible but different from polypropylene. In this case, and depending on the material utilized, the fabric obtained will be no longer 100% recyclable, but has however other interesting characteristics arising also from the characteristics of the material selected. For instance, the compatible material may be advantageously selected from polyamide and/or polyester.

### BRIEF DESCRIPTION OF THE DRAWINGS

By way of non limiting example of the present invention, the attached Figures are described, and in particular:

FIGS. 1 and 2 show the construction scheme of a polypropylene-based fabric; and

FIGS. 3 and 4 are schematic views showing engaging loops and counter-loops on opposite sides of the base fabric.

### DETAILED DESCRIPTION OF THE INVENTION

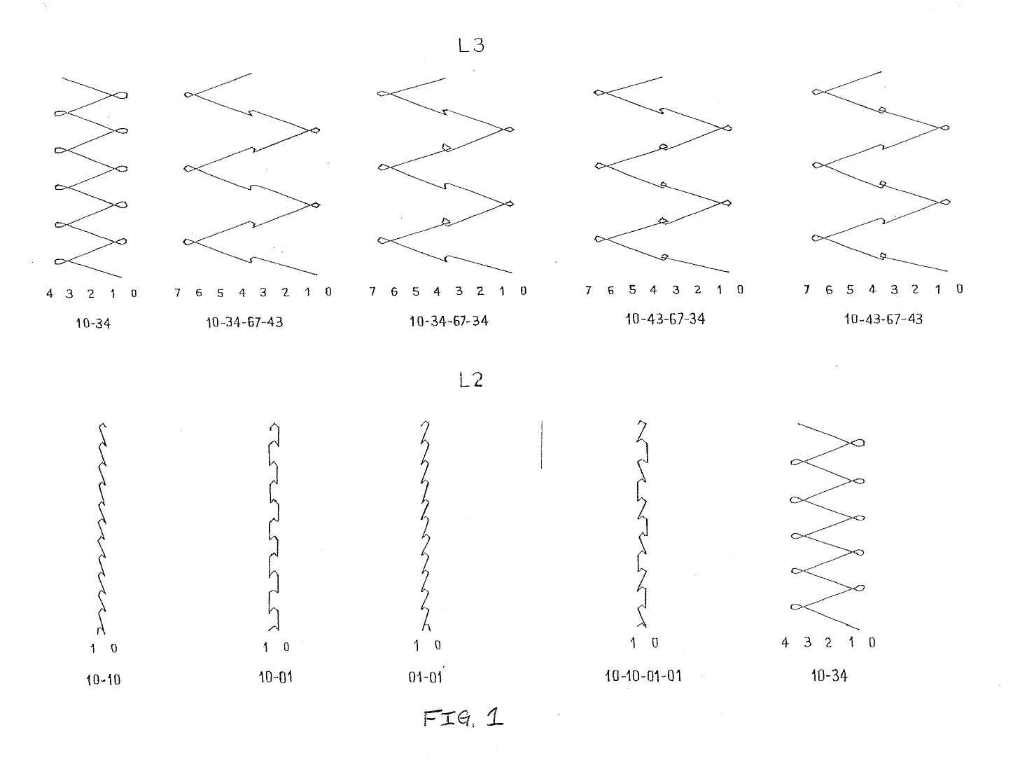

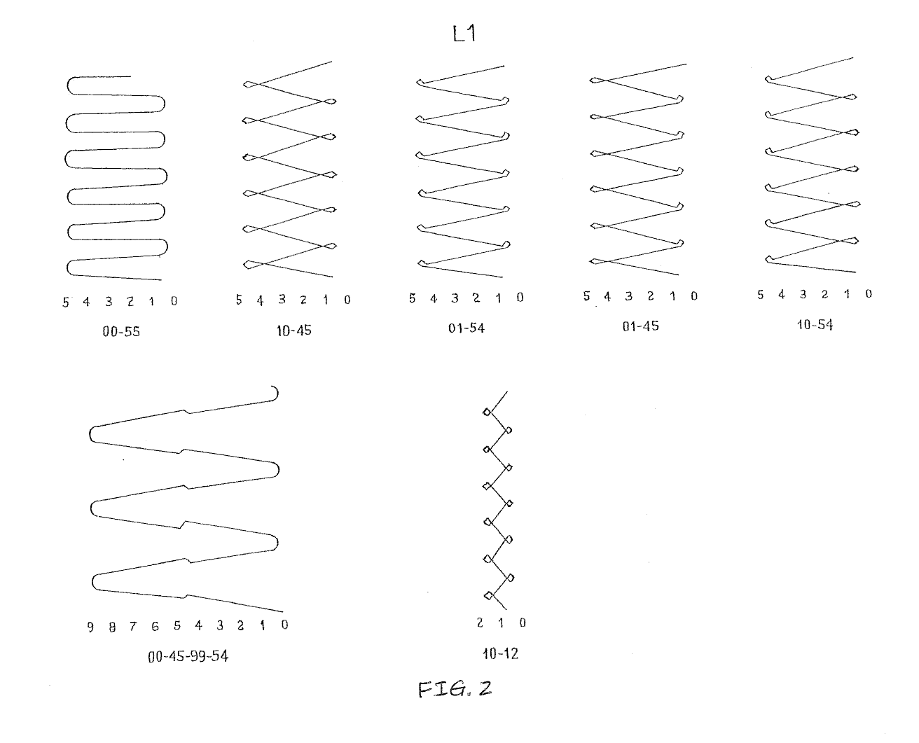

With reference to FIGS. 1 and 2, one observes that the drawings show some of the possible constructions realizable according to the present invention. In particular, L₁, L₂ and L₃ indicate the movement of the various combs (or “reeds”) or knitting bars operating on the looms employed for the realization of the above described and still other fabrics. For instance, to realize a fabric of the non-raised type, there may be advantageously utilized three-comb looms (multi-bar knitting) and therefore all the combinations possible between L₁, L₂ and L₃ lead to the formation of fabrics having different characteristics but provided all with the advantages previously described. Should one wish to realize a fabric of the raised type, there may be utilized for instance two-comb looms (bars), and as a consequence all the combinations between L₁ and L₂ will be possible. In any case, both types of looms may be utilized for the realization of the above described fabrics. The pattern of the base yarn, i.e., the yarn that forms the base fabric, is carried out by movement of both combs L₁ and L₂, while the pattern of the knitted yarn, i.e., the yarn that forms the eyelets (or loops), is carried out by movement of the comb L₃ operating on the knitting machine.

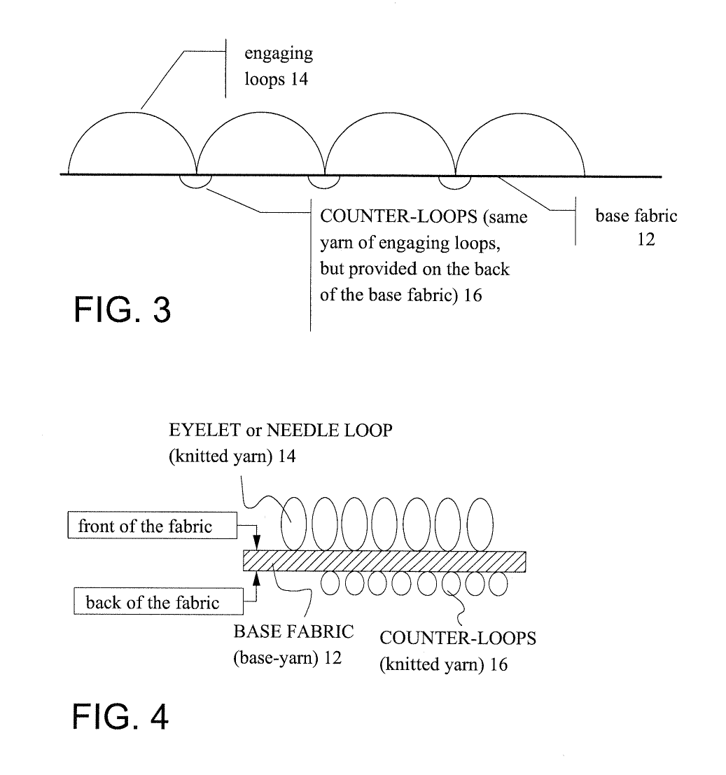

With reference to FIGS. 3 and 4, the resulting product is constructed with a base fabric 12, which is made of yarns, wherein on a front surface of the base fabric 12 are eyelets or needle loops 14 for engaging the hook element of another fabric/component, and on the back of the base fabric 12 are provided counter-loops 16. The needle loops 14, the base fabric 12 and the counter-loops 16 are preferably made of the same yarns. Such yarns comprise at least two portions including a base portion that forms the base fabric and a knitted portion that forms the needle loops and the counter-loops on opposite sides of the base fabric. That is, each yarn has a base portion, which contributes to form the base fabric 12, and a knitted portion, which forms needle loops 14 and counter-loops 16. The counter-loops provide an enlarged surface to couple the fabric with a hot-melt film or the like thanks to the capillary effect of their multi-filament yarns that absorb the melt film. This facilitates coupling of the fabric with the hot-melt film. Moreover, when the fabric is coupled to an underlying hot melt film, the counter-loops are pressed between the film and the fabric, thereby leading (supporting) engaging loops located on the other side of the fabric to stand in a vertical position. This facilitates coupling of the engaging loops with hooks of another fabric.

Always according to the invention and as said above, the polypropylene yarn employed may be of the continuous filament or staple type with a yarn count comprised between NE 5/1 and NE100/1. Two- or three-combs (multi-bar) knitting or rachel looms may be utilized according to the fabric type to be obtained and also weft insertion, rachel, stitch-bonding, circular knitting, chain-weft looms. The fabric according to the invention may have a fineness equal to or lower than 40.

According to an embodiment of the invention, the fabric is a polypropylene warp knitted loop fabric, also called “female” part, which with the “main loops” are able to mechanically interact and engage in a reversible manner with an extruded hook component, so-called “male” part. This “male” part may also be provided on a different fabric and does not necessarily form part of the present invention.

The “female” fabric (provided with loops/engaging loops) can be permanently coupled with a different fabric or support, on the opposite side (counter-loop side) with respect to the side provided with loops (engaging loops), so that major loops or engaging loops will be free to be engaged with a “male” fabric. When the female fabric is supported on a fabric or on a support of any kind, the permanent bonding between the “female” fabric and the support can be carried out much easier thanks to the presence of the “counter-loops” provided on the opposite side in respect to the “main loops” or “engaging loops.”

The support is preferably permanently and irreversibly bonded to the “female” fabric, while the “male” fabric engaging the main loops will create a reversible and temporary engagement. The “counter-loops” and the polypropylene yarn jointly will allow a better irreversible bonding with a fabric or a support of any kind, especially the ultra lightweight fabrics, and will allow the use of different methods of bonding that will no more be limited to the use of glues but can be done without any additional chemical material, thanks to the use of thermo bonding.

With reference to the “knitted fabric” as well as to the “knitting process and apparatus,” the described embodiments are intended to encompass “warp-knitted fabric” as well as a “warp-knitting process and apparatus.”

Some examples of practical realization of fabrics realized according to the present invention will be now reported by way of non limiting explanation of the present invention.

### Example 1

### “Raised” Fabric

L₁ comb or knitting bar weave 10-12
L₂ comb or knitting bar weave 10-34

### Example 2

### “Terry” Fabric

L₁ comb or knitting bar weave 00-55
L₂ comb or knitting bar weave 10-01
L₃ comb or knitting bar weave 10-43-67-34

### Example 3

### “Terry” Fabric

L₁ comb or knitting bar weave 10-45
L₂ comb or knitting bar weave 10-01
L₃ comb or knitting bar weave 10-34-67-43
In the examples the term “comb” refers to each bar L₁, L₂ and L₃, while the term “weave” refers to the kind of weave obtained by the corresponding bar.

The fabric according to the invention may be submitted to serial raising and cutting operations, according to the intended use thereof. The use of three knitting bars (L₁, L₂ and L₃) and with reference to Example 3 with the indicated movement of the three knitting bars, gives raise to the fabric provided with the noted counter-loops. The textile knitting construction is representative of simple superimposition of the constructions of L₁, L₂ and L₃ when each is selected as indicated in Example 3.

In particular, as said above, the polypropylene-based fabric is advantageously employed for the realization of mechanical fastening systems especially intended for, among other sectors, the personal care sector. These products are of great interest, especially when they are made entirely from polypropylene, and therefore entirely recyclable, coupleable by ultrasound and/or heat, without having to use glues/resins that jeopardize the natural non-toxicity and recycling possibility of the products.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A recyclable polypropylene-based knitted fabric having a weight between 10 and 300 g/m², suitable to engage with hook elements of another fabric/component, the fabric comprising a base knitted fabric, loops formed on a front of the base knitted fabric, and counter-loops formed on a back of the base knitted fabric, wherein the base knitted fabric is made of at least a base knitted yarn and the loops and the counter-loops are made of at least a loop knitted yarn, and wherein the fabric comprises the following construction:
L₁ knitting bar 10-45 with the base knitted yarn,
L₂ knitting bar 10-01 with the base knitted yarn,
L₃ knitting bar 10-34-67-43 with the loop knitted yarn.

2. The fabric according to claim 1, wherein a weight of the fabric ranges from 10 to 150 g/m².

3. The fabric according to claim 1, wherein a weight of the fabric ranges from 10 to 100 g/m².

4. The fabric according to claim 1, wherein a weight of the fabric ranges from 10 to 50 g/m².

5. The fabric according to claim 1, wherein each of said base yarn and said knitted yarn is a continuous mono-filament yarn.

6. The fabric according to claim 1, wherein each of said base yarn and said knitted yard is a continuous multi-filament yarn.

7. The fabric according to claim 1, wherein the fabric is formed according to a non raised configuration.

8. The fabric according to claim 1, comprising a yarn count lower than or equal to 150 deniers.

9. The fabric according to claim 1, wherein said base yarn and said knitted yarn have a yarn count between NE 5/1 and NE100/1.

10. The fabric according to claim 1, constructed such that the fabric is capable of being heat-coupled with similarly or differently constructed fabrics.

11. The fabric according to claim 1, constructed such that the fabric is capable of being ultrasound-coupled with similarly or differently constructed fabrics.

12. Systems for the mechanical fastening from polypropylene fabric according to claim 1.
